(19) United States
(12) Patent Application Publication
(10) Pub. No.: US 2012/0200041 A1
(43) Pub. Date: Aug. 9, 2012

(54) METHOD OF MANUFACTURING ARCHERY TARGET

(75) Inventor: Keith Simmons, Shannon, MS (US)

(73) Assignee: INTER-PAC, Inc., Tupelo, MS (US)

(21) Appl. No.: 13/301,987

(22) Filed: Nov. 22, 2011

Related U.S. Application Data
(60) Provisional application No. 61/420,126, filed on Dec. 6, 2010.

(51) Int. Cl. F41J 3/00; B29C 43/40

(52) U.S. Cl. 273/408; 156/267

(57) ABSTRACT

A method of manufacturing an archery target comprises the steps of providing a plurality of sheets of polyethylene foam, laminating the plurality of sheets of foam together by passing adjacent ones of the sheets past a heat source and then compressing the sheets together to form a polyethylene foam plank, and cutting a section out of the polyethylene foam plank.

### RELATED APPLICATIONS

This application claims priority to U.S. Provisional Patent Application Ser. No. 61/420,126 filed Dec. 6, 2010, which is hereby incorporated by reference herein as if fully set forth in its entirety.

### FIELD OF THE INVENTION

The subject matter herein relates to archery targets, and more particularly to an archery targeted fabricated of multiple layers of polyethylene foam sheet.

### BACKGROUND OF THE INVENTION

It is known to use polyethylene foam sheet in the manufacture of archery targets. One technique for fabricating such archery targets is disclosed in U.S. Pat. Nos. 7,258,345 and 7,464,938. In these patents, an archery target is manufactured by stacking a plurality of layers of foam with the bottom surface of an upper layer engaging the top surface of a lower layer in face-to-face engagement to form a stack having a top surface, a bottom surface and a plurality of side surfaces. The foam layers are compressed and the layers of foam are secured to each other by applying heat to the side surfaces such that a plurality of target faces of at least partially melted foam are formed. The layers of foam are further integrated to one another by applying a heated rod through the entire stack to form at least one hole extending through the layers.

A disadvantage of the target made according to the aforementioned U.S. Pat. Nos. 7,258,345 and 7,464,938 is that the layers have to be bound very tightly and a fairly high density of foam must be used in order to effectively stop arrows striking the target. This is because the layers of polyethylene foam are only welded to one another along their edges and along the edges of the holes formed through the target.

It is desirable to improve upon the targets of U.S. Pat. Nos. 7,258,345 and 7,464,938 and the manufacture thereof.

### SUMMARY OF THE INVENTION

Accordingly, in one aspect, the invention is a method of manufacturing an archery target comprising the steps of providing a plurality of sheets of polyethylene foam, laminating the plurality of sheets of foam together by passing adjacent ones of the sheets past a heat source and then compressing the sheets together to form a polyethylene foam plank, and cutting a section out of the polyethylene foam plank.

The foam plank can have a thickness of about 25 inches. The sheets of polyethylene foam can have a density of about 1.0 lb/cubic foot to about 9.0 lb/cubic foot. The sheets of polyethylene foam can have a thickness of about ⅛ inch to about 1 inch. The heat source can be a heated wire or heated air or a heated wire and heated air. The section can be a cube.

In another aspect, the invention is a method of manufacturing an archery target comprising the steps of providing a plurality of sheets of polyethylene foam, laminating the plurality of sheets of foam together by passing adjacent ones of the sheets past a first heat source and then compressing the sheets together to form a first polyethylene foam plank of a first thickness, laminating a plurality of the first polyethylene foam planks together by passing adjacent ones of the planks past a second heat source and then compressing the planks together to form a second polyethylene foam plank of a second thickness, and cutting a section out of the second polyethylene foam plank.

The first thickness can be up to about 5 inches. The second thickness can be up to about 25 inches. The sheets of polyethylene foam can have a density of about 1.0 lb/cubic foot to about 9.0 lb/cubic foot. The sheets of polyethylene foam can have a thickness of about ⅛ inch to about 1 inch. The first heat source can be a heated wire. The second heat source can be heated air. The section can be a cube.

In another aspect, the invention is an archery target comprising a plurality of sheets of polyethylene foam stacked in face-to-face relation, adjacent ones of the sheets being laminated together in that adjacent surfaces of the adjacent ones of the sheets are completely laminated to one another across an entire common surface area of the adjacent surfaces.

The adjacent surfaces can be heat welded to one another. The sheets of polyethylene foam can have a density of about 1.0 lb/cubic foot to about 9.0 lb/cubic foot. The sheets of polyethylene foam can have a thickness of about ⅛ inch to about 1 inch. The target can be in the shape of a cube having side dimensions up to about 25 inches per side.

The accompanying drawings, which are incorporated in and constitute a part of this specification, illustrate embodiments of the invention and, together with the summary of the invention given above, and the detailed description of the drawings given below, serve to explain the principles of the invention.

### BRIEF DESCRIPTION OF THE DRAWINGS

FIG. 1 is a side view of one step in the process of the invention.

FIG. 2 is a top view of the process of FIG. 1.

FIG. 3 is a side view of another step in the process of the invention.

FIG. 4 is a perspective view of an archery target made by the process of the invention.

### DETAILED DESCRIPTION OF THE DRAWINGS

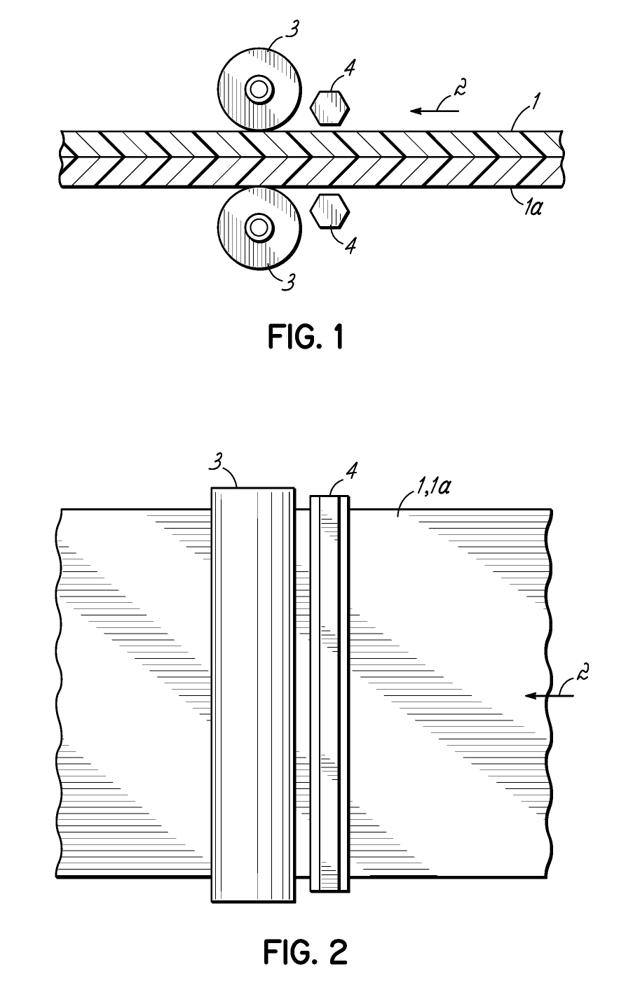

Referring first to FIGS. 1 and 2, a pair of polyethylene foam sheets 1, 1a is illustrated being processed by one step in the method of the present invention. As illustrated, the foam sheets 1, 1a travel in the direction of arrow 2 between a pair of opposing rollers 3, 3 and between a pair of opposing heat sources 4, 4, for example heated wires, upstream of the rollers 3, 3. The rollers 3, 3 could be heated rollers, either in addition to the heat sources 4, 4 or in lieu thereof. As the foam sheets 1, 1a pass between the heat sources 4, 4, heat is applied to the foam sheets 1, 1a to soften them. As the foam sheets 1, 1a pass between the rollers 3, 3, the rollers 3, 3 compress the confronting surfaces of the foam sheets 1, 1a together. The heat-softened confronting surfaces of the foam sheets 1, 1a become heat fused or heat welded or heat laminated together.

As mentioned above, one or both of the rollers 3, 3 can be the sole heat source, one or two heat sources 4, 4 separate from the rollers 3, 3 can be the sole heat source, or heat can be supplied from one or both of the rollers 3, 3 and one or two heat sources 4, 4. All such variations are deemed to be embraced by the invention.

The sheets of polyethylene foam can have a density of about 1.0 lb/cubic foot to about 9.0 lb/cubic foot and can have a thickness of about ⅛ inch to about 1 inch. Once a pair of the sheets has been laminated per the process of FIGS. 1 and 2, the process is repeated with the two laminated sheets and a third sheet, and so on, until a polyethylene foam plank of about 5 inches in thickness has been produced.

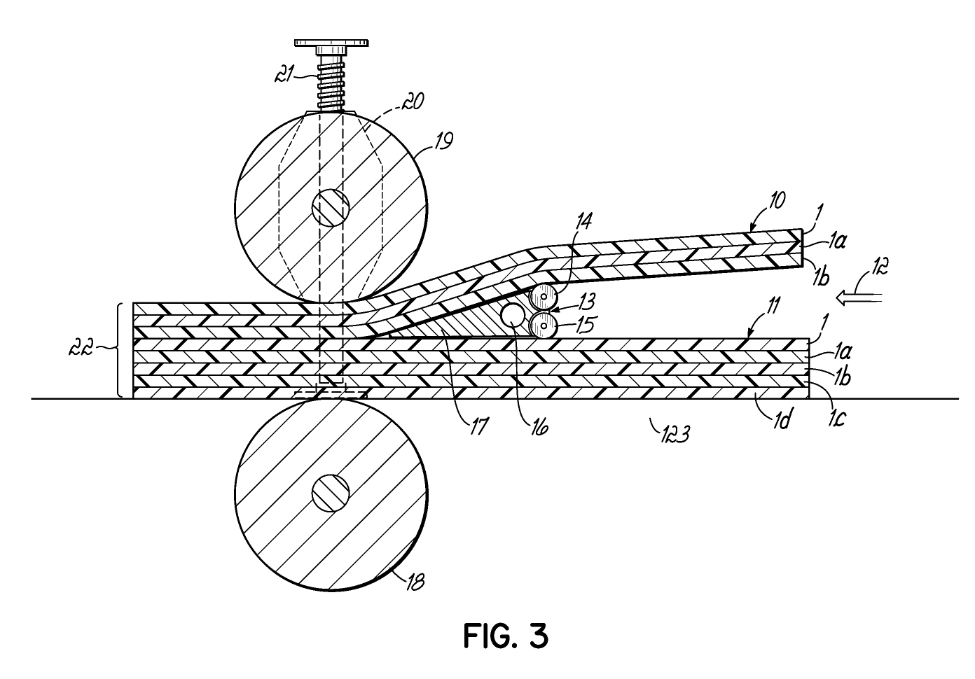

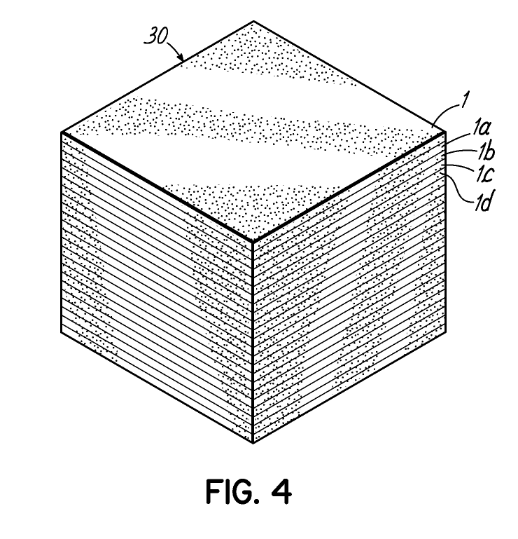

Next, several such 5 inch thick polyethylene foam planks, for example five planks, are laminated according to the process of FIG. 3 to produce a polyethylene foam plank of about 25 inches thick. Referring to FIG. 3, an upper foam plank 10 and a lower foam plank 11 are shown traveling in the direction of arrow 12. Note that while upper foam plank 10 is shown comprised of three sheets of foam 1, 1a, and 1b, and while lower foam plank 11 is shown comprised of five sheets of foam 1, 1a, 1b, 1c, and 1d, the invention is not limited to any particular number of foam sheets for the planks 10, 11. A hot air dispenser 13 is positioned between the foam planks 10, 11. The hot air dispenser 13 includes upper and lower rollers 14, 15 to facilitate the foam planks 10, 11 passing over and under the hot air dispenser 13. The hot air dispenser includes a hot air inlet 16 and a hot air director 17 for directing hot air between the foam planks 10, 11. After passing over and under the hot air dispenser 13, the foam planks are compressed between a lower roller 18 and an upper roller 19. Upper roller 19 is mounted on a carriage 20. Carriage 20 is mounted on a screw 21. Screw 21 allows for the upper roller 19 to be adjusted up or down to obtain the desired compression on the planks 10, 11 and/or thickness of the resulting laminated plank 22. The heat-softened confronting surfaces of the foam planks 10, 11 become heat fused or heat welded or heat laminated together.

Once a pair of the planks 10, 11 has been laminated to produce the plank 22 per the process of FIG. 3, the process is repeated with the laminated plank 22 and a third plank 10 or 11, and so on, until a polyethylene foam plank of about 25 inches in thickness has been produced. Once the final plank thickness has been achieved, a section is cut out of the plank, for example a cube, to produce the archery target 30. See FIG. 4.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. Accordingly, the scope of the invention shall be limited only by the following claims and their equivalents.

What is claimed is:

1. A method of manufacturing an archery target comprising the steps of:
providing a plurality of sheets of polyethylene foam,
laminating the plurality of sheets of foam together by passing adjacent ones of the sheets past a heat source and then compressing the sheets together to form a polyethylene foam plank, and
cutting a section out of the polyethylene foam plank.

2. The method of claim 1 wherein the foam plank has a thickness of about 25 inches.

3. The method of claim 1 wherein the sheets of polyethylene foam have a density of about 1.0 lb/cubic foot to about 9.0 lb/cubic foot.

4. The method of claim 1 wherein the sheets of polyethylene foam have a thickness of about ⅛ inch to about 1 inch.

5. The method of claim 1 wherein the heat source is a heated wire or heated air or a heated wire and heated air.

6. The method of claim 1 wherein the section is a cube.

7. A method of manufacturing an archery target comprising the steps of:
providing a plurality of sheets of polyethylene foam,
laminating the plurality of sheets of foam together by passing adjacent ones of the sheets past a first heat source and then compressing the sheets together to form a first polyethylene foam plank of a first thickness,
laminating a plurality of the first polyethylene foam planks together by passing adjacent ones of the planks past a second heat source and then compressing the planks together to form a second polyethylene foam plank of a second thickness, and
cutting a section out of the second polyethylene foam plank.

8. The method of claim 1 wherein the first thickness is up to about 5 inches.

9. The method of claim 1 wherein the second thickness is up to about 25 inches.

10. The method of claim 1 wherein the sheets of polyethylene foam have a density of about 1.0 lb/cubic foot to about 9.0 lb/cubic foot.

11. The method of claim 1 wherein the sheets of polyethylene foam have a thickness of about ⅛ inch to about 1 inch.

12. The method of claim 1 wherein the first heat source is a heated wire.

13. The method of claim 1 wherein the second heat source is heated air.

14. The method of claim 1 wherein the section is a cube.

15. An archery target comprising:
a plurality of sheets of polyethylene foam stacked in face-to-face relation,
adjacent ones of said sheets being laminated together in that adjacent surfaces of said adjacent ones of said sheets are completely laminated to one another across an entire common surface area of said adjacent surfaces.

16. The archery target of claim 9 wherein said adjacent surfaces are heat welded to one another.

17. The archery target of claim 9 wherein the sheets of polyethylene foam have a density of about 1.0 lb/cubic foot to about 9.0 lb/cubic foot.

18. The method of claim 1 wherein the sheets of polyethylene foam have a thickness of about ⅛ inch to about 1 inch.

19. The archery target of claim 9 wherein said target is in the shape of a cube having side dimensions up to about 25 inches per side.
